(19) United States
(12) Patent Application Publication
(10) Pub. No.: US 2013/0256927 A1
(43) Pub. Date: Oct. 3, 2013

(54) LENS AND LENS FABRICATION METHOD

(71) Applicant: SAMSUNG ELECTRONICS CO., LTD., Gyeonggi-do (KR)

(72) Inventors: Doo-Sik SHIN, Yongin-si (KR); Hyun-Ho YU, Seoul (KR); Sung-Wook CHOI, Gyeonggi-do (KR)

(73) Assignee: Samsung Electronics Co., Ltd., Gyeonggi-do (KR)

(21) Appl. No.: 13/852,074

(22) Filed: Mar. 28, 2013

(30) Foreign Application Priority Data
Apr. 2, 2012 (KR) 10-2012-0033899

(51) Int. Cl. B29D 11/00

(52) U.S. Cl. CPC B29D 11/00009
USPC 264/1.38

(57) ABSTRACT

Provided is a lens fabrication method including filling liquid-phase resin in a first mold, primarily hardening the liquid-phase resin by heating the liquid-phase resin, secondarily hardening the primarily-hardened resin by irradiating Ultraviolet (UV) rays to the primarily-hardened resin to form a lens, and separating the lens from the first mold.

### CLAIM OF PRIORITY

This application claims the benefit under 35 U.S.C. §119(a) of a Korean Patent Application filed in the Korean Intellectual Property Office on Apr. 2, 2012 and assigned Serial No. 10-2012-0033899, the entire disclosure of which is hereby incorporated by reference.

### BACKGROUND OF THE INVENTION

1. Field of the Invention

The present invention generally relates to an optical lens and a method for fabricating the lens.

2. Description of the Related Art

Lenses made of resin materials have been used for various optical devices such as a mobile device, a camera device, and so forth.

One of conventional resin lens fabrication methods is an injection method which heats solid resin, injects liquid-phase (or liquefied) resin into a mold, and hardens the injected liquid-phase resin in the mold. However, the degree or shape of molding slightly differs according to a degree to or a time for which the liquid-phase resin injected into the mold is hardened, thus making it difficult to provide a precise and mass fabrication of lenses.

For these reasons, a lens fabrication method which injects liquid-phase resin into a mold and irradiates Ultraviolet (UV) rays to the liquid-phase resin has been attempted. However, in this method, as the resin in the liquid state is hardened directly to the solid state, the shrinkage rate of the resin is excessive, thereby making it difficult to fabricate a lens having a precise shape as intended.

According to a conventional lens fabrication method using UV-curing resin, as liquid resin in a predetermined-shape mold is drastically changed into the solid state, the volume of the resin changes, resulting in a shrunk-shape lens in comparison to the mold. To correct the shrunk volume, lens designing considering the shrinkage rate has been attempted, but the performance of a lens varies even with several um of tolerance in such method. As a result, it has not been easy to fabricate high-quality lenses in a consistent manner.

### SUMMARY OF THE INVENTION

Objects of particular embodiments of the present invention are intended to at least partially solve, alleviate, or remove at least one of problems and/or disadvantages associated with prior arts.

Accordingly, the present invention provides a method for fabricating a lens a high-precision and high-performance lens with improved yield by minimizing the shrinkage rate of resin.

According to an aspect of the present invention, there is provided a lens fabrication method including filling liquid-phase resin in a first mold, primarily hardening the liquid-phase resin by heating the liquid-phase resin, secondarily hardening the primarily-hardened resin by irradiating Ultraviolet (UV) rays to the primarily-hardened resin to form a lens, and separating the lens from the first mold.

According to another aspect of the present invention, there is provided a lens fabricated using the foregoing lens fabrication method.

### BRIEF DESCRIPTION OF THE DRAWINGS

The above and other features and advantages of exemplary embodiments of the present invention will be more apparent from the following detailed description taken in conjunction with the accompanying drawings, in which:

FIG. 1 is a diagram for illustrating a lens fabrication method according to the present invention;

FIG. 2 is another diagram for illustrating a lens fabrication method according to the present invention;

FIG. 3 is another diagram for illustrating a lens fabrication method according to the present invention;

FIG. 4 is another diagram for illustrating a lens fabrication method according to the present invention;

FIG. 5 is another diagram for illustrating a lens fabrication method according to the present invention;

FIG. 6 is another diagram for illustrating a lens fabrication method according to the present invention;

FIG. 7A is a side cross-sectional view of a lens according to the present invention;

FIG. 7B is a floor plan of the lens according to the present invention; and

FIG. 8 is a flowchart illustrating a lens fabrication method according to an embodiment of the present invention.

### DETAILED DESCRIPTION OF THE EXEMPLARY EMBODIMENT

As the present invention allows for various changes and numerous embodiments, particular embodiments will be illustrated in the drawings and described in detail. However, the present invention is not limited to the specific embodiments and should be construed as including all the changes, equivalents, and substitutions included in the spirit and scope of the present invention.

Although ordinal numbers such as “first”, “second”, and so forth will be used to describe various components, those components are not limited by the terms. The terms are used only for distinguishing one component from another component. For example, a first component may be referred to as a second component and likewise, a second component may also be referred to as a first component, without departing from the teaching of the inventive concept. The term “and/or” used herein includes any and all combinations of one or more of the associated listed items.

The terminology used herein is for the purpose of describing an embodiment only and is not intended to be limiting of an exemplary embodiment. As used herein, the singular forms are intended to include the plural forms as well, unless the context clearly indicates otherwise. It will be further understood that the terms “comprises” and/or “has” when used in this specification, specify the presence of stated feature, number, step, operation, component, element, or a combination thereof but do not preclude the presence or addition of one or more other features, numbers, steps, operations, components, elements, or combinations thereof.

The terms used herein, including technical and scientific terms, have the same meanings as terms that are generally understood by those skilled in the art, as long as the terms are differently defined. It should be understood that terms defined in a generally-used dictionary have meanings coinciding with those of terms in the related technology. As long as the terms are not defined obviously, they are not ideally or excessively analyzed as formal meanings.

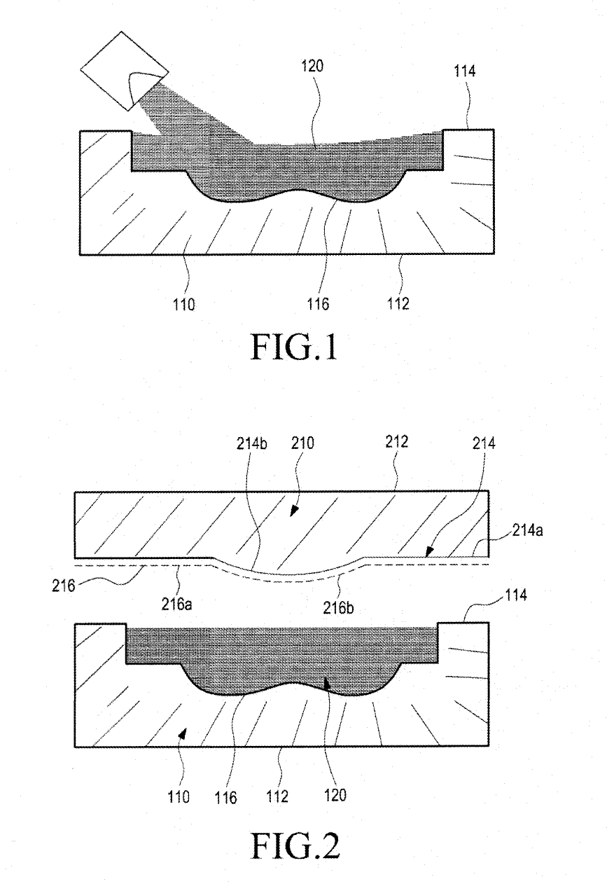

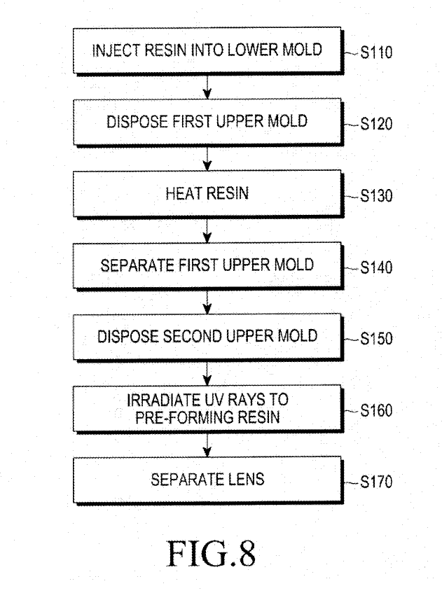

FIGS. 1 through 7B are diagrams for describing a lens fabrication method according to the present invention. FIG. 8 is a flowchart illustrating a lens fabrication method according to an embodiment of the present invention.

As shown, the lens fabrication method includes a process of injecting resin into a lower mold (step S110), a process of disposing a first upper mold (step S120), a process of heating resin (step S130), a process of separating the first upper mold (step S140), a process of disposing a second upper mold (step S150), a process of irradiating Ultraviolet (UV) rays to pre-forming resin (step S160), and a process of separating a lens (step S170).

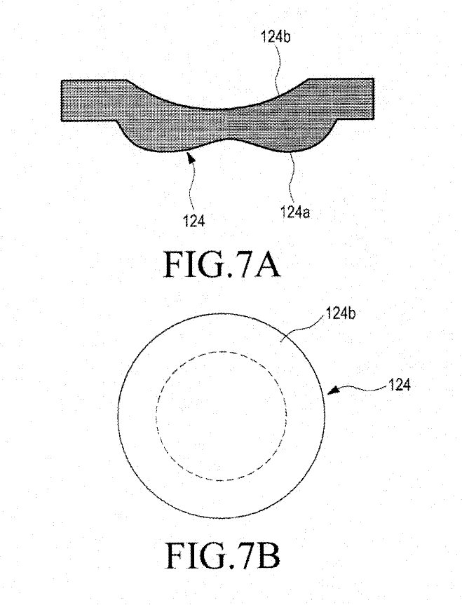

FIGS. 7A and 7B illustrate a lens formed using a lens fabrication method according to the present invention. More specifically, FIG. 7A is a side cross-sectional view of a lens 124 and FIG. 7B is a floor plan of the lens 124.

As shown, a first lens surface 124a is an aspherical surface which has a concave center portion and a convex peripheral portion, and a second lens surface 124b is a concave surface which is provided at the opposite end of the first lens surface 124a and has a preset radius of curvature. The first lens surface 124a and the second lens surface 124b refract incident light to converge or diverge the light. Each of the first lens surface 124a and the second lens surface 124b has a shape in which a peripheral portion (hereinafter, a flat portion) has a flat surface and a center portion (hereinafter, a curved portion) has a curved surface (a concave or convex surface). Note that the lens fabrication method according to the present invention may be applied to fabricate a lens having a first lens surface and a second lens surface. Each lens surface may be a spherical surface, a flat surface, or an ashperical shape.

Hereinafter, the process of obtaining the above lens shown in FIGS. 7 according to the operation steps of FIG. 8 will be described with reference to FIGS. 1 through 6.

Referring to FIG. 1, at step S110, liquid resin 120 which is a raw material for the lens 124 is injected (or filled) into a groove 116 of a lower mold 110. The lower mold 110 includes a bottom surface 112 which is a flat surface and a top surface 114 is positioned in opposition to the bottom surface 112 and has the groove 116. A bottom surface of the groove 116 has a shape which is substantially the same as a first lens surface 124a of the lens 124 shown in FIG. 7A. The lower mold 110 is formed of a material which is transparent to Ultraviolet (UV) rays and has high heat conductivity, such as a glass or resin material. Resin 120, which is a raw material for the lens 124, can be semi-hardened by heat, and the resin 120 can be fully hardened by heat and UV rays. Semi-hardened resin has a deformable shape and forms a gel which is a solid, jelly-like material. For example, the resin 120 may be a substance in which general UV-curing resin is used as a base and a small amount of thermo-setting resin (or a thermo-setting additive) is mixed in the UV-curing resin. For another example, LU-102 series resin manufactured by Nippon Steel Chemical Co., Ltd. may be used as the resin 120.

Referring to FIG. 2, at step S120, a first upper mold 210 is fixed and disposed (or coupled) over the lower mold 110. Here, the first upper mold 210 may be mounted on the lower mold 110 using a separate fixing apparatus. The first upper mold 210 is formed of a high heat-conductivity material, for example, a glass, resin, or metallic material.

The first upper mold 210 includes a top surface 212 which is a flat surface and a convex bottom surface 214 which is positioned in opposition to the top surface 212. The bottom surface 214 of the first upper mold 210 has a shape which is similar to a second lens surface 124b of the lens 124 shown in FIG. 7A. In FIG. 2, a shape 216 of the second lens surface 124b is virtually indicated by a dotted line, and will be referred to as a virtual second lens surface. A peripheral portion 214a (hereinafter, also referred to as a flat portion) of the bottom surface 214 of the first upper mold 210 is flat and a center portion 214b (hereinafter, also referred to as a protruding portion or a curved portion) of the bottom surface 214 is in a convex form. In other words, the first upper mold 210 has a flat plate and a protruding portion which protrudes downwardly from a bottom surface of the flat plate. When a flat portion 216a of the virtual second lens surface 216 and a flat portion 214a of the first upper mold 210 are in contact with each other, a protruding height of the protruding portion 214b of the first upper mold 210 is set to be smaller than a recessed depth of the curved portion 216b of the virtual second lens surface 216 by about 3-5% of a thickness of the lens 124. That is, the virtual second lens surface 216 corresponds to the second lens surface 124b shown in FIG. 7A, and the bottom surface 214 is used instead of the virtual second lens surface 216 to accommodate for a shrinkage of the resin 120. Such setting has been made considering that the resin 120 has a shrinkage rate of about 4% when being hardened. That is, a 10 volume of a space defined by the first upper mold 210 and the lower mold 110 (and resin filled in the space as well) is greater by about 3-6% than a volume of the lens 124. The protruding portion 214b of the first upper mold 210 is inserted into the groove 116.

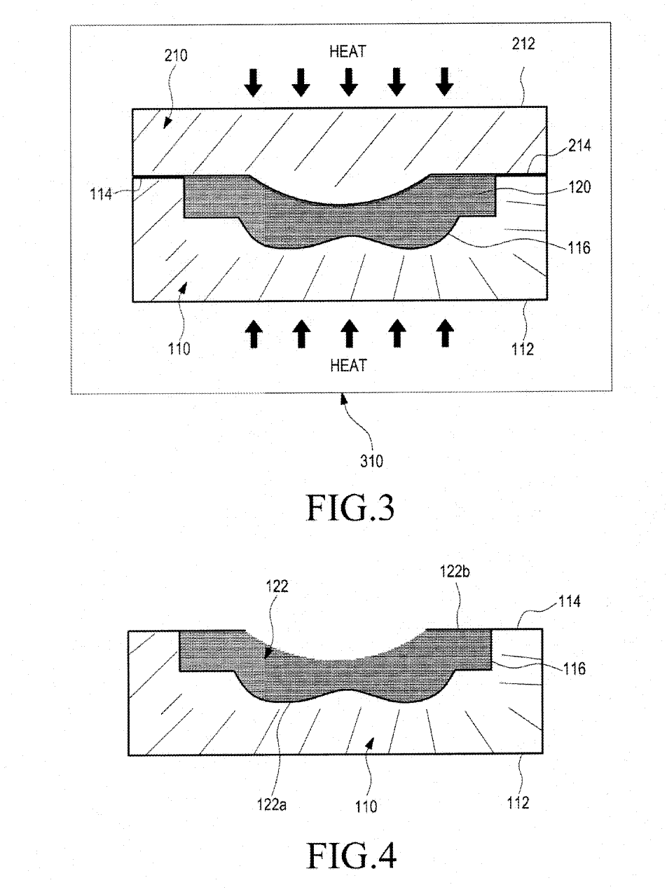

Referring to FIG. 3, at step S130, the coupled first upper mold 210 and lower mold 110 are disposed in a heating furnace (or heat chamber) 310 and the heating furnace 310 operates to heat the resin 120. By using the heating furnace 310, the resin 120 is heated to about 250-260° C. for about 5-15 seconds. Through such heating, the resin 120 has a semi-hardened state (or semi-hardened phase). The semi-hardened resin is called pre-forming resin 122.

The present invention primarily hardens the liquid-phase (or liquefied) resin 120 through heating to form the pre-forming resin 122, before secondarily hardening the resin 120 by irradiating UV rays to the resin 120, thereby reducing a rate of resin shrinkage caused by drastic hardening.

Referring to FIG. 4, at step S140, the coupled first upper mold 210 and lower mold 110 are taken out of the heating furnace 310, and the first upper mold 210 is separated (or removed). The pre-forming resin 122 formed through the foregoing process has a bottom surface 122a having substantially the same shape as the first lens surface 124a of the lens 124 illustrated in FIG. 7 and a top surface 122b having a similar shape to the second lens surface 124b. That is, the top surface 122b of the pre-forming resin 122 has substantially the same shape as the bottom surface 214 of the first upper mold 210. After removing the first upper mold 210 and prior to performing the next step S150, the pre-forming resin 122 may be cooled at room temperature for about 10 seconds or more.

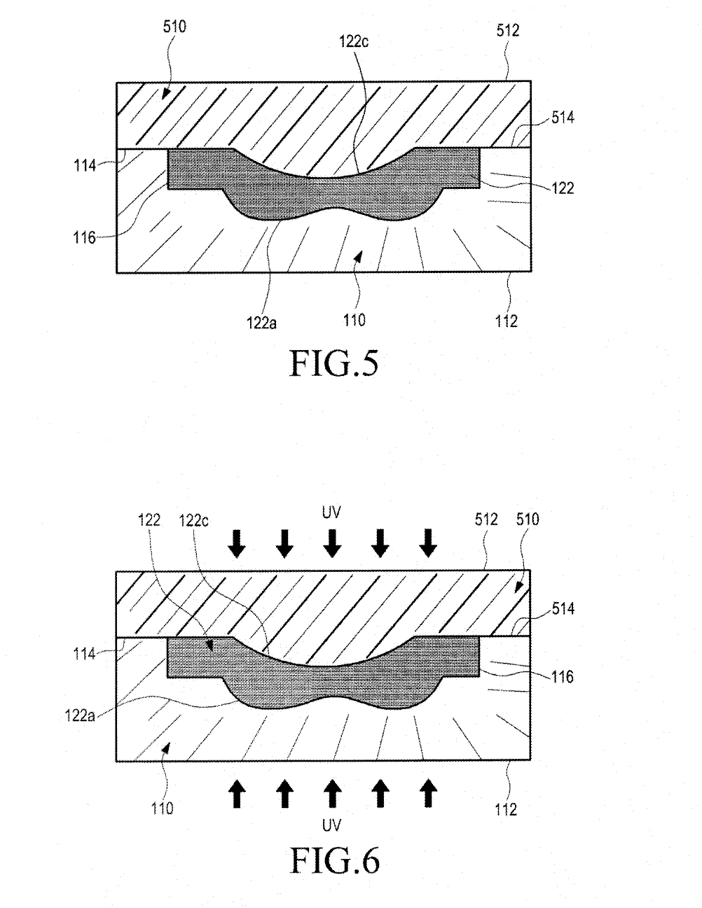

Referring to FIG. 5, at step S150, a second upper mold 510 is fixed and disposed (or coupled) on the lower mold 110. For example, the second upper mold 510 may be mounted on the lower mold 110 by using a separate fixing apparatus. The second upper mold 510 includes a top surface 512 which is a flat surface and a bottom surface 514 which is positioned in opposition to the top surface 512 and has substantially the same shape as the second lens surface 124b of the lens 124. The second upper mold 510 is formed of a material which is transparent to UV rays and has high heat conductivity, such as a glass or resin material. A volume of a space defined by the second upper mold 510 and the lower mold 110 (and the pre-forming resin 122 filled in the space as well) is substantially equal to a volume of the lens 124. A top surface 122c of the pre-forming resin 120 has substantially the same shape as the bottom surface 514 of the second upper mold 510.

Like the first upper mold 210, the bottom surface 214 of the second upper mold 510 has a flat portion and a protruding portion (or curved portion). In other words, the second upper mold 510 has a flat plate and a protruding portion which protrudes downwardly from a bottom surface of the flat plate. A volume or protruding height of the protruding portion of the second upper mold 510 is greater than that of the protruding portion of the first upper mold 210. The bottom surface 214 of the second upper mold 510 corresponds to the second lens surface 124b shown in FIG. 7A. The protruding portion of the second upper mold 510 is inserted into the groove 116.

Referring to FIG. 6, at step S160, UV rays are irradiated to the coupled second upper mold 510 and lower mold 110 to fully harden the pre-forming resin 122. For example, the coupled second upper mold 510 and lower mold 110 are disposed in a UV chamber, and the UV chamber operates to harden the pre-forming resin 122. Through UV irradiation, the pre-forming resin 122 has a fully-hardened state, and the fully-hardened resin is a lens.

Referring to FIG. 7, at step S170, the coupled second upper mold 510 and lower mold 110 are separated and the lens 124 is separated from the lower mold 110.

While the first upper mold and the second upper mold have been used in the foregoing example, one upper mold may be used. That is, by using only the second upper mold, the lens may be fabricated without replacing the second upper mold. In this case, by adjusting an interval between the second upper mold and the lower mold, that is, widening the interval between the second upper mold and the lower mold in steps S120 and S130 and narrowing the interval between the second upper mold and the lower mold or causing the second upper mold and the lower mold to meet each other in steps S150 and S160, above-described effects corresponding to using two upper molds may be obtained.

In addition, molds for lens fabrication are divided into upper and lower molds in the foregoing example, but one mold into which the upper mold and the lower mold are formed integrally may also be used. In this case, by apply a low pressure to the mold or removing an external pressure form the mold to increase a volume of the inner space of the mold in steps S120 and S130 and applying a high pressure to the mold to reduce the volume of the inner space of the mold in steps S150 and S160, the above-described effects corresponding to the use of two upper molds may be obtained.

Moreover, although the upper mold is coupled with the lower mold after the lower mold is filled with resin in the foregoing example, the resin may be injected into an inner space defined by the lower mold and the upper mold which are coupled to each other.

Furthermore, in the present invention, the lower mold may be referred to as a first mold and the first and second upper molds may be referred to as second and third molds.

In the foregoing example, the liquid-phase resin is UV-cured after being thermo-set, but on the contrary, the liquid-phase resin may also be thermo-set after being UV-cured.

As is apparent from the foregoing description, when compared to a conventional lens fabrication process, a shrinkage rate of resin during resin solidification may be minimized. As the solidification shrinkage rate is minimized, a high-precision and high-performance lens may be fabricated and the yield of lens fabrication may be improved.

While the present invention has been particularly illustrated and described with reference to an exemplary embodiments thereof, various modifications or changes can be made without departing from the scope of the present invention. Therefore, the scope of the present invention is not limited to the disclosed embodiment, and it should be defined by the scope of the following claims and equivalents thereof.

What is claimed is:

1. A lens fabrication method, comprising:
filling liquid-phase resin in a first mold;
primarily hardening the liquid-phase resin by heating the liquid-phase resin;
secondarily hardening the primarily-hardened resin by irradiating Ultraviolet (UV) rays to the primarily-hardened resin to form a lens; and
separating the lens from the first mold.

2. The lens fabrication method of claim 1, wherein the first mold comprises a groove in which the liquid-phase resin is filled, and the primarily hardening comprises:
disposing a second mold comprising a first protruding portion on the first mold; and
primarily hardening the liquid-phase resin by heating the liquid-phase resin in a state where the first mold and the second mold are coupled.

3. The lens fabrication method of claim 2, wherein the second mold is formed of a high heat-conductivity material.

4. The lens fabrication method of claim 2, wherein the liquid-phase resin is heated in a heating furnace.

5. The lens fabrication method of claim 4, wherein the liquid-phase resin is heated to about 250-260° Celsius for about 5-15 seconds.

6. The lens fabrication method of claim 2, wherein the forming of the lens comprises:
separating the second mold from the first mold;
disposing a third mold comprising a second protruding portion on the first mold, the second protruding portion corresponds to a lens surface of the lens; and
secondarily hardening the primarily-hardened resin by irradiating the UV rays to the primarily-hardened resin in a state where the first mold and the third mold are coupled, to form the lens.

7. A lens fabricated using a lens fabrication method according to claim 1.
